(19) United States
(12) Patent Application Publication
(10) Pub. No.: US 2016/0292605 A1
(43) Pub. Date: Oct. 6, 2016

(54) PROVIDING DATA ANALYSIS IN EVALUATING PROJECT OPPORTUNITIES

(71) Applicant: Accenture Global Services Limited, Dublin (IE)

(72) Inventor: James R. Lipinski, Hyde Park, VT (US)

(21) Appl. No.: 14/676,287

(22) Filed: Apr. 1, 2015

(51) Int. Cl. G06Q 10/06

(52) U.S. Cl. CPC G06Q 10/06313

(57) ABSTRACT

Methods, systems, and apparatus, including computer programs encoded on a computer storage medium, for generating graphical representations based on aggregated data associated with project opportunities. For each project opportunity in a set of project opportunities to be evaluated, project opportunity data, a set of organization criterion scores, and a set of partner criterion scores are received. An organization preference score is determined, based on combining the organization criterion scores. A partner preference score is determined, based on combining the partner criterion scores. A graphical representation of the project opportunity is generated, based on the project opportunity data that corresponds to aspects of the project opportunity. The graphical representation of the project opportunity is presented among graphical representations of other project opportunities, based on the organization preference score and the customer preference score.

### BACKGROUND

Data visualization techniques can be used to communicate data by encoding data as visual objects presented through graphics (e.g., graphs, charts, or diagrams). In some cases, graphics are generated from data provided by a database. A graphical user interface (GUI) can provide a user with a view of data at a display device.

### SUMMARY

Implementations of the present disclosure include computer-implemented methods for generating graphical representations based on aggregated data associated with one or more project opportunities. In some implementations, actions include, for each project opportunity in a set of project opportunities to be evaluated, receiving project opportunity data that corresponds to one or more aspects of the project opportunity, receiving a set of organization criterion scores for a corresponding set of organization criteria, each organization criterion score representing an evaluation of the project opportunity in regard to a corresponding organization criterion, receiving a set of partner criterion scores for a corresponding set of partner criteria, each partner criterion score representing an evaluation of the project opportunity in regard to a corresponding partner criterion, determining an organization preference score, based on combining the organization criterion scores, determining a partner preference score, based on combining the partner criterion scores, and generating a graphical representation of the project opportunity, based on the project opportunity data that corresponds to the one or more aspects of the project opportunity. The graphical representation of the project opportunity can be presented among graphical representations of other project opportunities, based on the organization preference score and the customer preference score. Other implementations of this aspect include corresponding systems, apparatus, and computer programs, configured to perform the actions of the methods, encoded on computer storage devices.

These and other implementations can each optionally include one or more of the following features. The organization criterion scores, the partner criterion scores, or both can be derived from one or more pieces of data. Determining the organization preference score can include weighting one or more of the organization criterion scores. Determining the partner preference score can include weighting one or more of the partner criterion scores. The project opportunity data can include data that corresponds to a project value, and an overall size of the graphical representation of the project opportunity can be proportional to the project value. The project opportunity data can include data that corresponds to a project date, and a border thickness of the graphical representation of the project opportunity can be inversely proportional to an amount of time between a current date and the project date. The project opportunity data can include data that corresponds to a project stage, and a border color of the graphical representation of the project opportunity can correspond to the project stage. The project opportunity data can include data that corresponds to a project servicer, and an interior color of the graphical representation of the project opportunity can correspond to the project servicer. Partner stakeholder data that corresponds to one or more partner stakeholders can be received. One or more of the organization criterion scores, one or more of the partner criterion scores, or both, can be modified based on the partner stakeholder data. The partner stakeholder data can include, for each of a set of partner stakeholders, a funding value that indicates an amount of funding influenced by the partner stakeholder, and a relationship quality score that indicates a quality of relationship between the partner stakeholder and the organization. For each partner stakeholder in the set of partner stakeholders, a graphical representation of the partner stakeholder can be generated. A size of the graphical representation of the partner stakeholder can be proportional to the funding value. A color of the graphical representation of the partner stakeholder can correspond to the relationship quality score. The graphical representation of the partner stakeholder can be presented among graphical representations of other partner stakeholders, based on the funding value. A graphical representation of the set of organization criterion scores and a graphical representation of the set of partner criterion scores can be generated, and the graphical representation of the set of organization criterion scores can be presented along with the graphical representation of the set of partner criterion scores. The project opportunity data can include data that corresponds to a project value, data that corresponds to a project stage, and data that corresponds to a project date, and for each project opportunity in the set of project opportunities to be evaluated, a second graphical representation of the project opportunity can be generated. An overall size of the second graphical representation of the project opportunity can be proportional to the project value, and an interior color of the second graphical representation of the project opportunity can correspond to the project stage. The second graphical representation of the project opportunity can be presented among second graphical representations of other project opportunities, based on the project date.

Implementations of the present disclosure provide one or more of the following advantages. In some examples, implementations of the present disclosure enable multiple visualizations to be generated from a data source. As data provided by the data source is modified, the multiple visualizations can be updated automatically.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 depicts an example system that can execute implementations of the present disclosure.

FIG. 2 depicts an example process that can be executed in implementations of the present disclosure.

FIG. 3 depicts an example information graphic of organization and partner criterion scores.

FIG. 4 depicts an example information graphic of project opportunities based on organization and partner preferences.

FIG. 5 depicts an example information graphic of a project opportunity pipeline.

FIG. 6 depicts an example information graphic of partner stakeholders

### DETAILED DESCRIPTION

Implementations of the present disclosure are generally directed to receiving, aggregating, and processing data from disparate data sources to provide efficient data analysis in evaluating project opportunities. In some examples, data associated with a set of project opportunities can be entered, scored, ranked, and visually displayed to facilitate a prioritization of the project opportunities. For example, an organization (e.g., a business, a society, an association, or another organized group) may have many opportunities for projects (e.g., units of paid or non-paid work that have a particular purpose) which they may or may not pursue. A project, for example, may be undertaken by the organization for a partner (e.g., a client, an associate, or another entity that engages services of the organization). In accordance with implementations of the present disclosure, for each project opportunity in a set of project opportunities, data can be received, the data can be processed, and a visualization of the project opportunity can be generated and presented among visualizations of other project opportunities, based on the processed data. The received data, for example, can include data that corresponds to the project opportunity, data that corresponds to an evaluation of the project opportunity with regard to an organization, and data that corresponds to an evaluation of the project opportunity with regard to a partner. In some examples, multiple visualizations of project opportunity data, organization evaluation criteria, and partner evaluation criteria can be generated and presented, based on the received data.

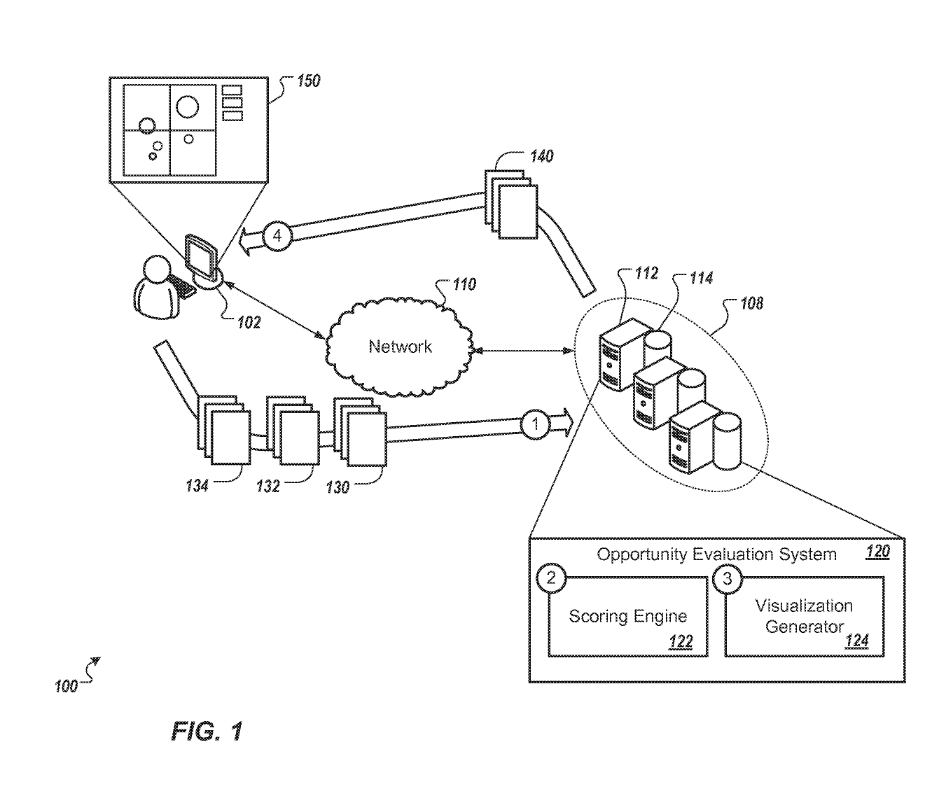

FIG. 1 depicts an example system 100 that can execute implementations of the present disclosure. In the depicted example, the system 100 includes a computing device 102 that communicates with a server system 108 over a network 110. In some examples, the computing device 102 can represent various forms of processing devices including, but not limited to, a desktop computer, a laptop computer, a tablet computer, a handheld computer, a personal digital assistant (PDA), a smart phone, a media player, an email device, a game console, or a combination of any two or more of these data processing devices or other data processing devices. As discussed in further detail herein, the computing device 102 can interact with software executed by the server system 108.

In some implementations, the server system 108 can include one or more servers 112 and databases 114. In some examples, the servers 112 can represent various forms of servers including, but not limited to a web server, an application server, a proxy server, a network server, or a server farm. For example, the servers 112 can be application servers that execute software accessed by computing device 102. In operation, multiple computing devices (e.g., clients) can communicate with the servers 112 by way of the network 110. In some implementations, a user can invoke applications available on the servers 112 in a user-interface application (e.g., a web browser) running on the computing device 102. Each application can individually access data from one or more repository resources (e.g., databases 114).

In some implementations, the system 100 can be a distributed client/server system that spans one or more networks such as network 110. The network 110 can be a large computer network, such as a local area network (LAN), wide area network (WAN), the Internet, a cellular network, or a combination thereof connecting any number of mobile clients, fixed clients, and servers. In some implementations, each client (e.g., computing device 102) can communicate with the server system 108 through a virtual private network (VPN), Secure Shell (SSH) tunnel, or other secure network connection. In some implementations, the network 110 can include the Internet, a wireless service network, and may include the Public Switched Telephone Network (PSTN). In other implementations, the network 110 may include a corporate network (e.g., an intranet) and one or more wireless access points.

In some implementations, the computing device 102 can execute software and can invoke applications locally available to the device, and each application can access data from one or more repository resources locally available to the device. For example, the computing device 102 can interact with software executed by the same device 102, with storage occurring on the device 102 or by the databases 114.

Implementations of the present disclosure are described herein with reference to a non-limiting, example context. The example context includes account planning data associated with a service providing organization. It is appreciated, however, that implementations of the present disclosure are applicable in other contexts and/or with other data and/or industries. In some implementations, the following example stages can be used for receiving, aggregating, and processing data from disparate data sources to provide efficient data analysis in evaluating project opportunities.

At stage 1, for example, an opportunity evaluation system 120 (e.g., included in the server system 108) can receive project opportunity data 130, a set of organization criterion scores 132 and a set of partner criterion scores 134 from the computing device 102, over the network 110. The project opportunity data 130, for example, can include data related to one or more project opportunities to be evaluated. The set of organization criterion scores 132, for example, can represent an evaluation of one or more project opportunities with regard to an organization. The set of partner criterion scores 134, for example, can represent an evaluation of one or more project opportunities with regard to one or more partners. The project opportunity data 130, organization criterion scores 132 and partner criterion scores 134 can be received by the opportunity evaluation system 120 as data files, as data strings, as data passed through function calls, or as data provided using another suitable technique. In some implementations, updates may be received for data values. For example, one or more elements of the project opportunity data 130 can be updated, one or more of the organization criterion scores 132 can be updated, and/or one or more of the partner criterion scores 134 can be updated, and the updates may be provided to the opportunity evaluation system 120.

At stage 2, for example, an organization preference score and a partner preference score can be determined for a project opportunity. For example, the opportunity evaluation system 120 can use a scoring engine 122 (e.g., a software module, object, or other suitable component, which may be combined or separate, and may be co-located or distributed) to determine the scores. The organization preference score, for example, can be determined by combining scores from the set of organization criterion scores 132. The partner preference score, for example, can be determined by combining scores from the set of partner criterion scores 134.

At stage 3, for example, a graphical representation of each project opportunity can be generated based on its respective project opportunity data, and the graphical representation can be placed among graphical representations of other project opportunities. For example, the opportunity evaluation system 120 can use a visualization generator 124 (e.g., a software module, object, or other suitable component, which may be combined or separate, and may be co-located or distributed) to generate and arrange the visualizations. In some implementations, data for rendering multiple information graphics (e.g., graphs, charts, diagrams) can be generated, based on the project opportunity data 130, the set of organization criterion scores 132, and the set of partner criterion scores 134.

At stage 4, for example, rendering data 140 for presenting one or more information graphics can be provided by the opportunity evaluation system 120 to the computing device 102, over the network 110. Upon receiving the rendering data 140, for example, the computing device 102 can render and display an information graphic 150. Based on the information graphic 150, for example, a user can readily identify one or more project opportunities to pursue, and can make informed decisions regarding how to pursue each project opportunity.

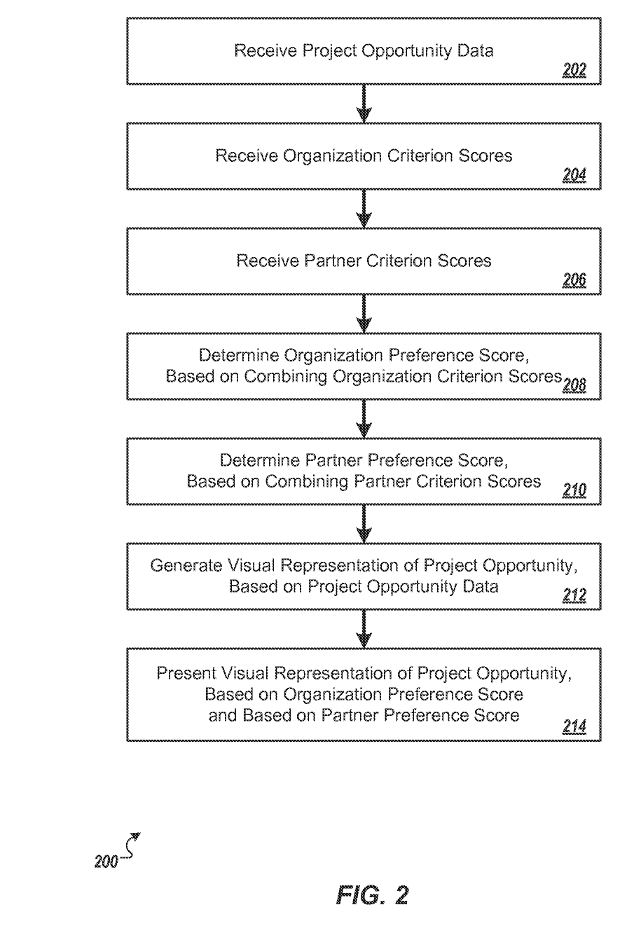

FIG. 2 depicts an example process 200 that can be executed in implementations of the present disclosure. The example process 200 can be implemented, for example, by the example environment 100 (shown in FIG. 1). In some implementations, the example process 200 can be provided by one or more computer-executable programs executed using one or more computing devices.

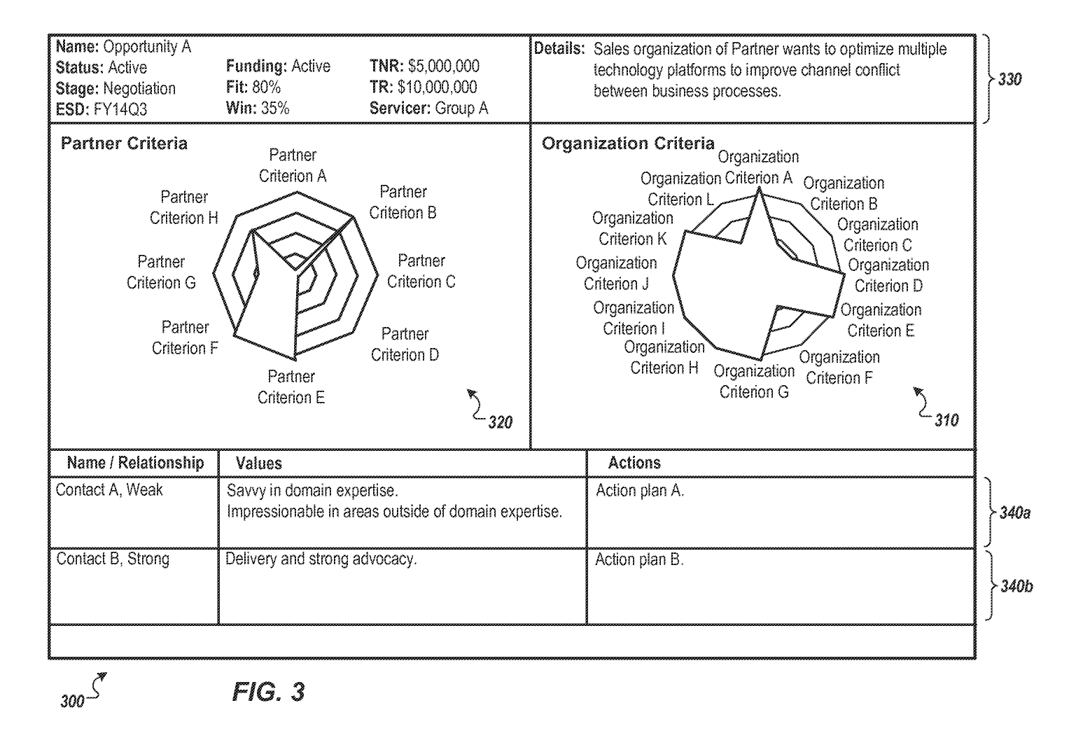

Project opportunity data is received (202). For example, the opportunity evaluation system 120 can receive the project opportunity data 130, which can include project opportunity data for each project opportunity in a set of project opportunities to be evaluated. A project opportunity, for example, can be a potential or ongoing project undertaken by an organization for a partner. The project opportunity data can correspond to one or more aspects of project opportunities, including project values, project dates, project stages, project servicers, and other suitable aspects. Project values, for example, may include total net revenue (e.g., a value of a particular project), total revenue (e.g., a value of the particular project plus potential follow-up projects over time), and/or estimated profit margins. Project dates, for example, may include estimated start dates and/or estimated completion dates. Project stages, for example, may include categorical designations of stages for securing a project opportunity, such as an investigation stage, a request for proposal stage, a bidding stage, a negotiation stage, and other relevant stages. Project servicers, for example, may include identifiers for one or more individuals and/or groups within an organization that can service a project for a partner. Other aspects of project opportunities included in the project opportunity data 130 are described below and with regard to FIG. 3.

Organization criterion scores are received for a corresponding set of organization criteria (204). For example, the opportunity evaluation system 120 can receive the set of organization criterion scores 132. Each organization criterion score can represent an evaluation of a project opportunity in regard to a corresponding organization criterion. Organization criteria, for example, can include various factors that are considered by organizations when evaluating project opportunities. For example, a particular organization may consider a partner's project budget, the organization's capabilities, the organization's knowledge of certain specific information about the partner, partner disclosures about its plans for the project, and other suitable factors. In some implementations, organization criteria may be customizable. For example, an organization can define organization criteria and can score a project opportunity based on the criteria.

For each of the project opportunities and for each of the organization criteria, a score can be received. The organization criteria may be scored directly (e.g., on a scale, or as a binary value), for example, and/or may be derived from one or more pieces of data (e.g., using a formula and/or a lookup table). In some implementations, an organization criterion score may be generated or modified, based on project opportunity data. For example, the project opportunity data 130 can indicate that a particular project is currently at a request for proposal stage. In the present example, an organization criterion score for intent to buy can be assigned a particular value (e.g., a high value), or the score for intent to buy can be modified (e.g., increased) by the scoring engine 122, based at least in part on a current project stage (e.g., a request for proposal stage) of a project opportunity.

Partner criterion scores are received for a corresponding set of partner criteria (206). For example, the opportunity evaluation system 120 can receive the set of partner criterion scores 134. Each partner criterion score can represent an evaluation of a project opportunity in regard to a corresponding partner criterion. Partner criteria, for example, can include various factors that are considered by partners when evaluating and selecting organizations for servicing projects. For example, a particular partner may consider budget factors, the organization's focus, an interest that partner stakeholders have in the project, and other suitable factors. In some implementations, partner criteria may be customizable for each partner of an organization. For example, a different set of partner criteria can be defined for each different partner, and a project opportunity can be scored based on a particular set of partner criteria that pertains to a partner associated with the project opportunity.

For each of the project opportunities and for each of the partner criteria, a score can be received. The partner criteria may be scored directly (e.g., on a scale, or as a binary value), for example, and/or may be derived from one or more pieces of data (e.g., using a formula and/or a lookup table). In some implementations, a partner criterion score may be generated or modified, based on project opportunity data. For example, the project opportunity data 130 can indicate that a particular project is associated with a project value that exceeds a particular threshold value, relative to a budget of a particular partner. In the present example, a partner criterion score for positive impact on budget attributed to the project can be assigned a particular value (e.g., a low value), or the score for positive impact on budget can be modified (e.g., reduced) by the scoring engine 122, based at least in part on the project value (e.g., a high value relative to a partner's budget) for the project opportunity.

In some implementations, partner stakeholder data may be received. For example, the opportunity evaluation system 120 can receive partner stakeholder data that can be included with the project opportunity data 130. Partner stakeholder data can correspond to one or more partner stakeholders (e.g., representatives, employees) associated with a partner of an organization. A partner stakeholder can be associated with one or more project opportunities, for example. Partner stakeholder data may include, for each partner stakeholder, a funding value that indicates an amount of funding influenced by the partner stakeholder, and/or a relationship quality score that indicates a quality of relationship between the partner stakeholder and the organization.

One or more organization criterion scores can be generated or modified based on partner stakeholder data. For example, a relationship quality score for a partner stakeholder associated with a project opportunity may indicate that the partner stakeholder has a weak relationship with an organization. In the present example, an organization criterion score related to the organization's knowledge of a particular aspect of the partner can be modified (e.g., reduced) by the scoring engine 122, based at least in part on the relationship quality score for the partner stakeholder. As another example, when multiple partner stakeholders are associated with a project opportunity, relationship quality scores for each of the partner stakeholders can be aggregated (e.g., averaged) when modifying an organization criterion score.

One or more partner criterion scores can be generated or modified based on partner stakeholder data. For example, a relationship quality score for a partner stakeholder associated with a project opportunity may indicate that the partner stakeholder has a strong relationship with an organization. In the present example, a partner criterion score related to an interest that partner stakeholders have in the project can be modified (e.g., increased) by the scoring engine 122, based at least in part on the relationship quality score for the partner stakeholder. As another example, when multiple partner stakeholders are associated with a project opportunity, relationship quality scores for each of the partner stakeholders can be aggregated (e.g., averaged) when modifying a partner criterion score.

In some implementations, a graphical representation of a set of organization criterion scores and a graphical representation of a set of partner criterion scores may be generated and presented. For example, the visualization generator 124 can generate one or more visualizations, and can provide rendering data 140 to the computing device 102 for presenting one or more corresponding information graphics (e.g., information graphic 150). Referring now to FIG. 3, for example, an example information graphic 300 of organization and partner criterion scores is shown. The information graphic 300, for example, can include a graphical representation 310 of a set of organization criterion scores, presented along with a graphical representation 320 of a set of partner criterion scores. The graphical representation 310 of the set of organization criterion scores, for example, can illustrate an evaluation of a particular project opportunity (e.g., “Opportunity A”) in regard to organization criteria, whereas the graphical representation 320 of the set of partner criterion scores can illustrate an evaluation of the particular project opportunity in regard to partner criteria. Each of the graphical representations 310 and 320, for example, can be a wheel diagram, with various criteria listed around the circumference of the wheel, and criterion scores represented by points placed between the center of the wheel and the circumference, with points representing low scores placed near the center and points representing high scores placed near the circumference. In the present example, the points representing criterion scores may be connected to form closed shapes. It is appreciated, however, that different graphical representations may be contemplated in other implementations.

In some implementations, project opportunity data associated with a project opportunity under evaluation may be presented along with a graphical representation of a set of organization criterion scores and along with a graphical representation of a set of partner criterion scores. The information graphic 300, for example, can include and/or illustrate project opportunity data for a particular project opportunity. In the present example, a presentation area 330 includes a project opportunity name/identifier (e.g., “Opportunity A”), a status (e.g., active), stage (e.g., a negotiating stage), an estimated start date (e.g., the third quarter of fiscal year 2014), funding (e.g., active), a fit percentage (e.g., 80%), a win probability (e.g., 35%), a total net revenue (e.g., $5,000,000), a total revenue (e.g., $10,000,000), a project servicer (e.g., “Group A”), and project opportunity detail notes.

In some implementations, partner stakeholder data associated with a project opportunity under evaluation may be presented along with a graphical representation of a set of organization criterion scores and along with a graphical representation of a set of partner criterion scores. The information graphic 300, for example, can include and/or illustrate partner stakeholder data (e.g., partner stakeholder name, relationship quality indicator, values, actions) related to one or more partner stakeholders associated with a project opportunity. In the present example, presentation area 340a includes information related to “Contact A,” an indication that the organization has a weak relationship with the partner stakeholder (e.g., a low relationship quality score), and various values and actions associated with the partner stakeholder. In the present example, presentation area 340b includes information related to “Contact B,” an indication that the organization has a strong relationship with the partner stakeholder (e.g., a high relationship quality score), and various values and actions associated with the partner stakeholder. In general, relationship quality scores can be used to generate and/or modify organization criterion scores and/or partner criterion scores, whereas other partner stakeholder data (e.g., values, actions) may be free text, and not used for generating/modifying scores.

Referring again to FIG. 2, an organization preference score is determined, based on combining organization criterion scores (208). For example, the opportunity evaluation system 120 can use the scoring engine 122 to combine (e.g., average, sum, aggregate based on a formula) the set of organization criterion scores 132. Determining the organization preference score may include weighting one or more of the organization criterion scores. For example, criterion scores for one or more of the organization criteria may be weighed more or less than criterion scores for other organization criteria (e.g., based on the relative importance of each organization criterion) when determining an overall organization preference score regarding a particular project opportunity.

A partner preference score is determined, based on combining partner criterion scores (210). For example, the opportunity evaluation system 120 can use the scoring engine 122 to combine (e.g., average, sum, aggregate based on a formula) the set of partner criterion scores 134. Determining the partner preference score may include weighting one or more of the partner criterion scores. For example, criterion scores for one or more of the partner criteria may be weighed more or less than criterion scores for other partner criteria (e.g., based on the relative importance of each partner criterion) when determining an overall partner preference score regarding a particular project opportunity.

A graphical representation of a project opportunity is generated, based on project opportunity data (212). For example, the visualization generator 124 can generate a graphical representation of each project opportunity to be evaluated, and can assign graphical attributes to the graphical representation that reflect the project opportunity data, such that a user can readily distinguish relative aspects of the project opportunities when the corresponding graphical representations are presented together in an information graphic. For example, project opportunities may be represented by shapes (e.g., circles, squares) including various graphical attributes, such as size, border thickness, border color, and interior color.

In some implementations, an overall size of a graphical representation of a project opportunity can be proportional to a project value. For example, the graphical representation of the project opportunity can be scaled in proportion to its estimated total net revenue or its estimated total revenue, such that graphical representations of project opportunities that are estimated to have relatively large amounts of revenue appear larger than graphical representations of project opportunities that are estimated to have lesser amounts of revenue.

In some implementations, a border thickness of a graphical representation of a project opportunity can be inversely proportional to an amount of time between a current date and a project date. For example, the graphical representation's border thickness can be scaled in inverse proportion to a number of days until an estimated start date or estimated completion date, such that graphical representations of project opportunities that are estimated to begin (or end) relatively soon have thicker borders than graphical representations of project opportunities that are estimated to begin (or end) later.

In some implementations, a border color of a graphical representation of a project opportunity can correspond to a project stage. For example, the graphical representation's border color can be assigned based on a categorical designation of a current stage for securing a project opportunity, such that graphical representations of project opportunities that are in an investigation stage have borders of a first color, graphical representations of project opportunities that are in a request for proposal stage have borders of a second color, graphical representations of project opportunities that are in a bidding stage have a third color, and graphical representations of project opportunities that are in a negotiation stage have a fourth color.

In some implementations, an interior color of a graphical representation of a project opportunity can correspond to a project servicer. For example, each project servicer (e.g., an individual and/or group assigned to service a project) within an organization can be associated with a different color. The graphical representation's interior color can be assigned such that the color corresponds to that of the project opportunity's project servicer.

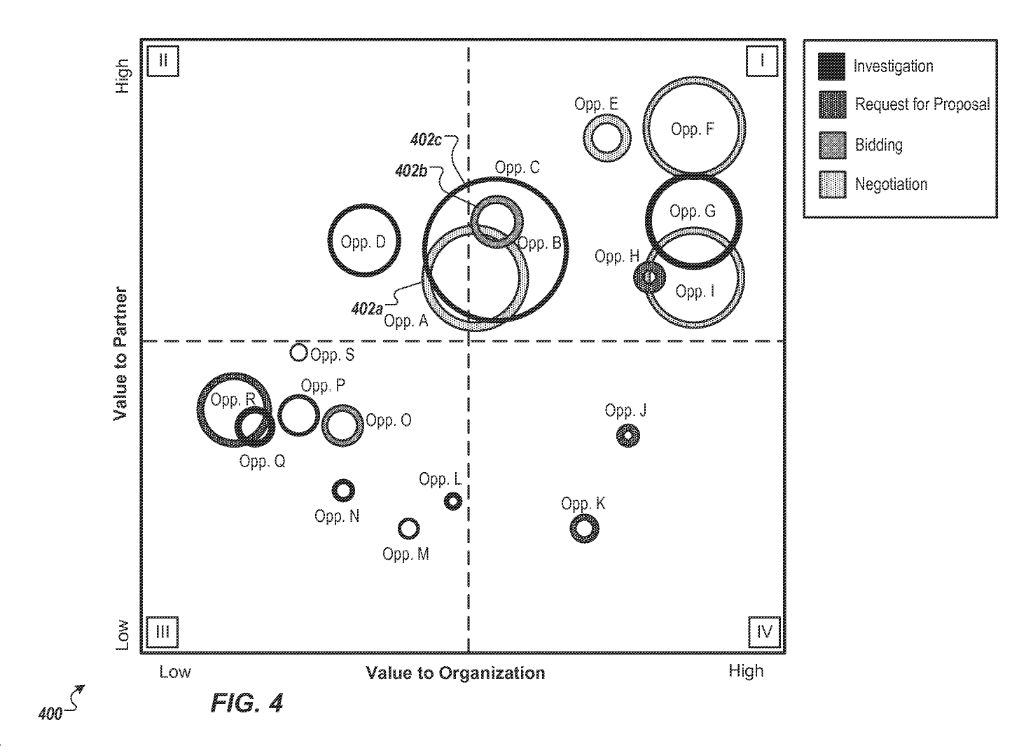

A graphical representation of a project opportunity is presented among graphical representations of other project opportunities, based on an organization preference score and based on a partner preference score (214). For example, the visualization generator 124 can generate one or more visualizations, and can provide rendering data 140 to the computing device 102 for presenting one or more corresponding information graphics (e.g., information graphic 150). Referring now to FIG. 4, for example, an example information graphic 400 of project opportunities based on organization and partner preferences is shown. The information graphic 400, for example, can include various graphical representations of various project opportunities (e.g., graphical representation 402a, which corresponds to “Opportunity A,” graphical representation 402b, which corresponds to “Opportunity B,” graphical representation 402c, which corresponds to “Opportunity C,” etc.), each graphical representation having graphical attributes that are based on project opportunity data of a corresponding project opportunity, and each graphical representation positioned within the information graphic 400 based on an organization preference score and based on a partner preference score of the project opportunity. For example, each of the graphical representations 402a, 402b, and 402c (of “Opportunity A,” “Opportunity B,” and “Opportunity C,” respectively) is scaled proportionately to its respective project value, has a border thickness that is inversely proportional to an amount of time between a current date and its respective project date, has a border color that corresponds to its respective project stage, and has an interior color that corresponds to its respective project servicer. Each of the graphical representations 402a, 402b, and 402c, for example, is placed within the information graphic 400 based on an organization preference score and a partner preference score of its respective project opportunity. For example, graphical representations of project opportunities associated with relatively high organization preference scores can be positioned further along an x-axis than project opportunities associated with relatively low organization preference scores, and graphical representations of project opportunities associated with relatively high partner preference scores can be placed further along a y-axis than project opportunities associated with relatively low partner preference scores.

In general, based on graphical attributes and positioning of graphical representations of project opportunities, multiple project opportunities can be evaluated and compared. Comparing the graphical representations 402a and 402b (corresponding to “Opportunity A” and “Opportunity B”), for example, it may be apparent that “Opportunity A” has a larger project value than “Opportunity B” (based on relative size), has a similar lead time (based on relative border thickness), and that “Opportunity A” is at a negotiation stage, whereas “Opportunity B” is at a bidding stage. Based on the relative positions of the graphical representations 402a and 402b (corresponding to “Opportunity A” and “Opportunity B”), for example, it may be apparent that “Opportunity B” is considered to be of somewhat greater value than “Opportunity A” to the organization and to the partner.

In some implementations, partner preference scores and organization preference scores for project opportunities presented within an information graphic for evaluating project opportunities may be scaled such that graphical representations of the project opportunities are distributed throughout the information graphic. For example, a highest point along an axis that represents a partner preference score can be designated to correspond with a highest score for partner preference among a set of project opportunities, and a highest point along an axis that represents an organization preference score can be designated to correspond with a highest score for organization preference among the set of project opportunities. By scaling partner preference scores and organization preference scores, for example, the information graphic 400 can be generated such that graphical representations of particular types of project opportunities are positioned in particular areas of the information graphic that correspond to relative levels of organization and partner preference.

In some implementations, an information graphic for evaluating project opportunities may be divided into quadrants, and each quadrant can correspond to a different strategy for pursuing project opportunities that have a corresponding graphical representation that is positioned within the quadrant. For example, graphical representations of project opportunities that are associated with higher than average partner preference scores and higher than average organization preference scores may be positioned within a first quadrant, indicating project opportunities that are to be prioritized. As another example, graphical representations of project opportunities that are associated with higher than average partner preference scores and lower than average organization preference scores may be positioned within a second quadrant, indicating project opportunities that may undergo further evaluation to determine what assets an organization may leverage. As another example, graphical representations of project opportunities that are associated with lower than average partner preference scores and lower than average organization preference scores may be positioned within a third quadrant, indicating project opportunities that may undergo further evaluation to determine what has not yet been considered in regard to the project opportunities. As another example, graphical representations of project opportunities that are associated with lower than average partner preference scores and higher than average organization preference scores may be positioned within a fourth quadrant, indicating project opportunities that may undergo further evaluation to determine how an organization can better demonstrate value to a partner.

In some implementations, an information graphic for evaluating project opportunities may be regenerated, based on updated partner preference scores, updated organization preference scores, updated project opportunity data, and/or an updated definition of a project opportunity data value. For example, a definition of project value may be updated from total net revenue (e.g., a value of a particular project) to total revenue (e.g., a value of the particular project plus follow-up projects over time), and graphical representations of project opportunities (e.g., graphical representation 402a, 402b, 402c, etc.) can be regenerated, and can repositioned within the information graphic 400, to reflect the updated definition. As another example, a definition of project date may be updated from estimated start date to estimated completion date, and graphical representations of project opportunities can be regenerated and can be repositioned.

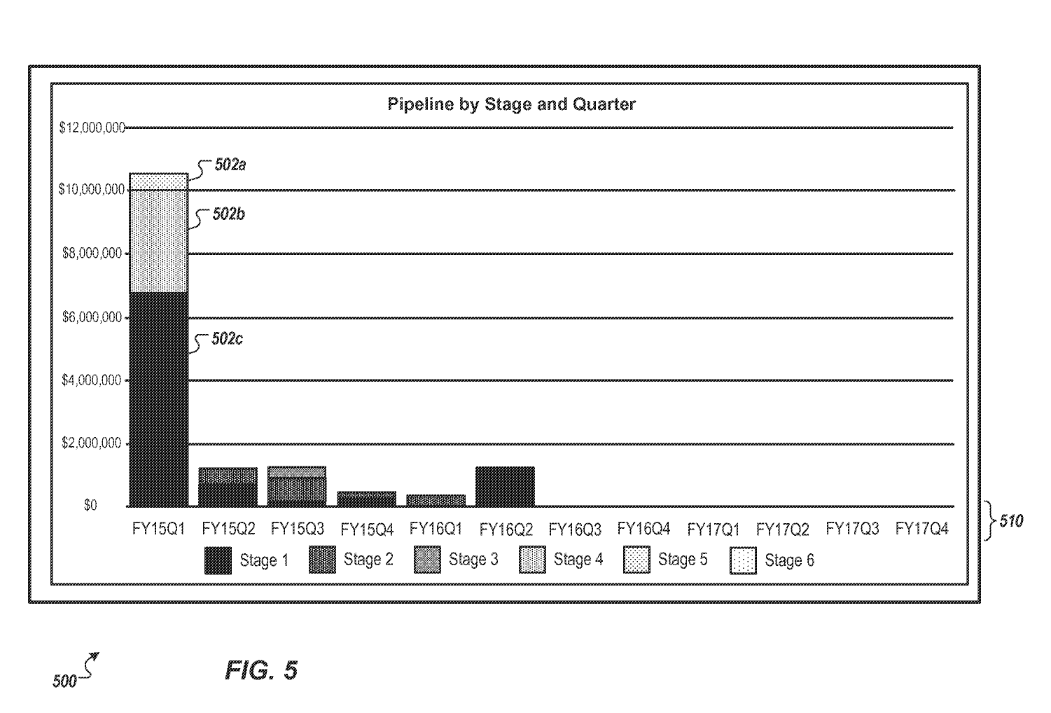

In some implementations, another graphical representation of a project opportunity may be generated, based on project opportunity data. For example, the visualization generator 124 can generate one or more visualizations, and can provide rendering data 140 to the computing device 102 for presenting one or more corresponding information graphics (e.g., information graphic 150). Referring now to FIG. 5, for example, an example information graphic 500 of a project opportunity pipeline is shown. The information graphic 500, for example, can include various graphical representations of various project opportunities (e.g., graphical representations 502a, 502b, and 502c), each graphical representation having graphical attributes that are based on project opportunity data of a corresponding project opportunity, and each graphical representation positioned within the information graphic 500 based on an amount of time between a current date and a project date of the project opportunity. For example, each of the graphical representations 502a, 502b, and 502c is scaled proportionately to its respective project value, has an interior color that corresponds to its respective project stage (or its respective project servicer), and is positioned along a timeline 510 according to its respective project date (e.g., estimated start date or estimated completion date).

In some implementations, graphical representations of project opportunities may be positioned and presented among graphical representations of other project opportunities, such that graphical representations of project opportunities having project dates that occur within a particular time period (e.g., a week, a month, a quarter, a year, or another suitable time period) are presented together, and a total value of project opportunities within the particular time period is visually displayed. For example, the graphical representations 502a, 502b, and 502c (e.g., graphical representations of project opportunities having project dates that occur within the first quarter of fiscal year 2015) may be presented together and stacked, such that a total value (e.g., $10,500,000) of project opportunities during the time period is apparent to a viewer.

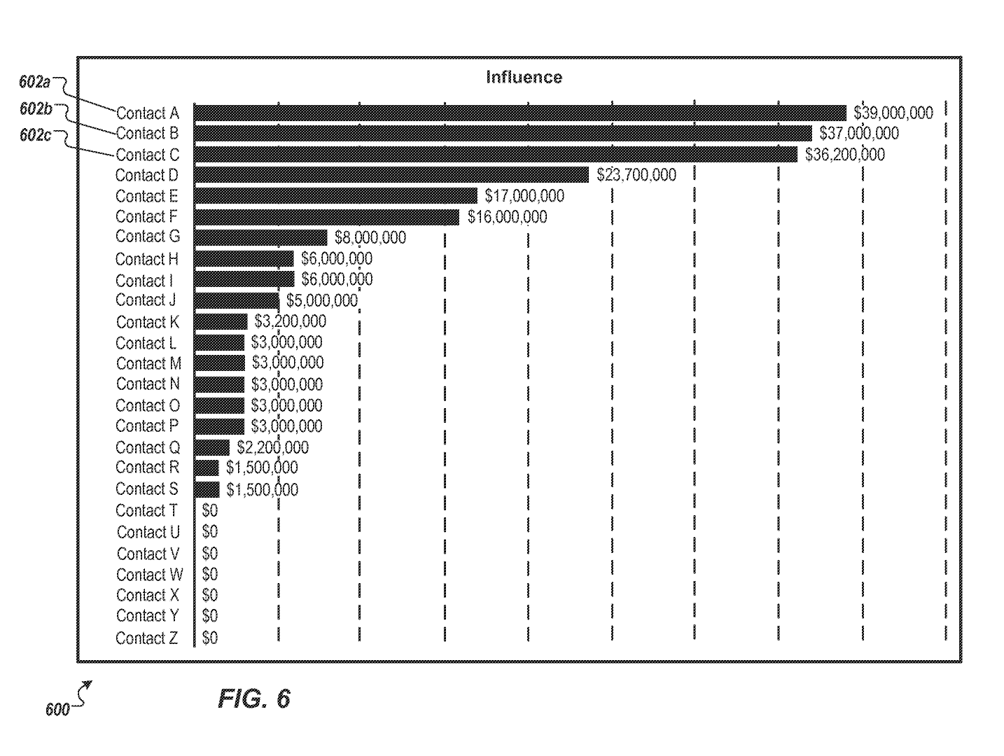

In some implementations, a graphical representation of a set of partner stakeholders may be generated and presented. For example, the visualization generator 124 can generate one or more visualizations, and can provide rendering data 140 to the computing device 102 for presenting one or more corresponding information graphics (e.g., information graphic 150). Referring now to FIG. 6, for example, an example information graphic 600 of partner stakeholders is shown. The information graphic 600, for example, can include graphical representations of various partner stakeholders (graphical representation 602a, which corresponds to “Contact A,” graphical representation 602b, which corresponds to “Contact B,” and graphical representation 602c, which corresponds to “Contact C,” etc.), each graphical representation having graphical attributes that are based on partner stakeholder data of a corresponding partner stakeholder. A size of a graphical representation of the partner stakeholder can be proportional to a funding value associated with the partner stakeholder. For example, the graphical representation 602a of “Contact A” can be a bar with a length that is proportional to an amount of funds (e.g., $39,000,000) controlled by or otherwise influenced by the partner stakeholder. A color of a graphical representation of a partner stakeholder can correspond to a relationship quality score associated with the partner stakeholder. For example, a graphical representation of a partner stakeholder that has a relationship quality score that indicates a strong relationship with an organization can be assigned a first color (e.g., green), a graphical representation of a partner stakeholder that has a relationship quality score that indicates an average relationship with the organization can be assigned a second color (e.g., yellow), and a graphical representation of a partner stakeholder that has a relationship quality score that indicates a weak relationship with the organization can be assigned a third color (e.g., red). A graphical representation of the partner stakeholder can be presented among graphical representations of other partner stakeholders, based on the funding value. For example, each of the graphical representations 602a, 602b, and 602c can be ordered in the information graphic 600 according to a funding value controlled by or otherwise influenced by a corresponding partner stakeholder, with graphical representations of partner stakeholders that are associated with high funding values positioned toward the top of the information graphic 600, and graphical representations of partner stakeholders that are associated with low funding values positioned toward the bottom. Based on the relative positions and graphical aspects (e.g., overall size, color) of graphical representations of project stakeholders (e.g., graphical representations 602a, 602b, 602c, etc.), for example, an amount of influence on funding and current strength of relationship may be apparent, and such information may be used to focus an organization's efforts in pursuing project opportunities.

In some examples, implementations of the present disclosure enable one or more aspects of a graphical representation of a project opportunity to be customizable by a user. For example, a user can be provided with an option that an interior color of a graphical representation of a project opportunity is to correspond to its respective project stage or its respective project servicer, based on user selection of the option. As another example, the user can be provided with an option to map particular project opportunity data values to particular colors.

In some examples, implementations of the present disclosure enable multiple visualizations to be generated from a data source. As data provided by the data source is modified, the multiple visualizations can be updated.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, implementations may be realized on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any appropriate form of sensory feedback, e.g., visual feedback, auditory feedback, or tactile feedback; and input from the user may be received in any appropriate form, including acoustic, speech, or tactile input.

Implementations may be realized in a computing system that includes a back end component, e.g., as a data server, or that includes a middleware component, e.g., an application server, or that includes a front end component, e.g., a client computer having a graphical user interface or a Web browser through which a user may interact with an implementation, or any appropriate combination of one or more such back end, middleware, or front end components. The components of the system may be interconnected by any appropriate form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method for generating graphical representations based on aggregated data associated with one or more project opportunities, the method being executed by one or more processors and comprising:
for each project opportunity in a set of project opportunities to be evaluated:
receiving project opportunity data that corresponds to one or more aspects of the project opportunity,
receiving a set of organization criterion scores for a corresponding set of organization criteria, each organization criterion score representing an evaluation of the project opportunity in regard to a corresponding organization criterion,
receiving a set of partner criterion scores for a corresponding set of partner criteria, each partner criterion score representing an evaluation of the project opportunity in regard to a corresponding partner criterion,
determining, by the one or more processors, an organization preference score, based on combining the organization criterion scores,
determining, by the one or more processors, a partner preference score, based on combining the partner criterion scores, and
generating, by the one or more processors, a graphical representation of the project opportunity, based on the project opportunity data that corresponds to the one or more aspects of the project opportunity; and
presenting the graphical representation of the project opportunity among graphical representations of other project opportunities, based on the organization preference score and the customer preference score.

2. The method of claim 1, wherein the organization criterion scores, the partner criterion scores, or both are derived from one or more pieces of data.

3. The method of claim 1, wherein determining the organization preference score includes weighting one or more of the organization criterion scores.

4. The method of claim 1, wherein determining the partner preference score includes weighting one or more of the partner criterion scores.

5. The method of claim 1, wherein the project opportunity data includes data that corresponds to a project value, and an overall size of the graphical representation of the project opportunity is proportional to the project value.

6. The method of claim 1, wherein the project opportunity data includes data that corresponds to a project date, and a border thickness of the graphical representation of the project opportunity is inversely proportional to an amount of time between a current date and the project date.

7. The method of claim 1, wherein the project opportunity data includes data that corresponds to a project stage, and a border color of the graphical representation of the project opportunity corresponds to the project stage.

8. The method of claim 1, wherein the project opportunity data includes data that corresponds to a project servicer, and an interior color of the graphical representation of the project opportunity corresponds to the project servicer.

9. The method of claim 1, further comprising receiving partner stakeholder data that corresponds to one or more partner stakeholders, wherein one or more of the organization criterion scores, one or more of the partner criterion scores, or both, are modified based on the partner stakeholder data.

10. The method of claim 9, wherein the partner stakeholder data includes, for each of a set of partner stakeholders, a funding value that indicates an amount of funding influenced by the partner stakeholder, and a relationship quality score that indicates a quality of relationship between the partner stakeholder and the organization.

11. The method of claim 10, further comprising:
for each partner stakeholder in the set of partner stakeholders, generating, by the one or more processers, a graphical representation of the partner stakeholder, wherein a size of the graphical representation of the partner stakeholder is proportional to the funding value, and wherein a color of the graphical representation of the partner stakeholder corresponds to the relationship quality score; and
presenting the graphical representation of the partner stakeholder among graphical representations of other partner stakeholders, based on the funding value.

12. The method of claim 1, further comprising:
generating, by the one or more processors, a graphical representation of the set of organization criterion scores and a graphical representation of the set of partner criterion scores; and
presenting the graphical representation of the set of organization criterion scores along with the graphical representation of the set of partner criterion scores.

13. The method of claim 1, wherein the project opportunity data includes data that corresponds to a project value, data that corresponds to a project stage, and data that corresponds to a project date, wherein the method further comprises:
for each project opportunity in the set of project opportunities to be evaluated, generating, by the one or more processors, a second graphical representation of the project opportunity, wherein an overall size of the second graphical representation of the project opportunity is proportional to the project value, and an interior color of the second graphical representation of the project opportunity corresponds to the project stage; and
presenting the second graphical representation of the project opportunity among second graphical representations of other project opportunities, based on the project date.

14. A non-transitory computer-readable storage medium coupled to one or more processors and having instructions stored thereon which, when executed by the one or more processors, cause the one or more processors to perform operations for modeling data, the operations comprising:
for each project opportunity in a set of project opportunities to be evaluated:
receiving project opportunity data that corresponds to one or more aspects of the project opportunity,
receiving a set of organization criterion scores for a corresponding set of organization criteria, each organization criterion score representing an evaluation of the project opportunity in regard to a corresponding organization criterion,
receiving a set of partner criterion scores for a corresponding set of partner criteria, each partner criterion score representing an evaluation of the project opportunity in regard to a corresponding partner criterion,
determining an organization preference score, based on combining the organization criterion scores,
determining a partner preference score, based on combining the partner criterion scores, and
generating a graphical representation of the project opportunity, based on the project opportunity data that corresponds to the one or more aspects of the project opportunity; and
presenting the graphical representation of the project opportunity among graphical representations of other project opportunities, based on the organization preference score and the customer preference score.

15. The computer-readable storage medium of claim 14, the operations further comprising receiving partner stakeholder data that corresponds to one or more partner stakeholders, wherein one or more of the organization criterion scores, one or more of the partner criterion scores, or both, are modified based on the partner stakeholder data.

16. A system, comprising:
one or more processors; and
a computer-readable storage device coupled to the one or more processors and having instructions stored thereon which, when executed by the one or more processors, cause the one or more processors to perform operations for modeling data, the operations comprising:
for each project opportunity in a set of project opportunities to be evaluated:
receiving project opportunity data that corresponds to one or more aspects of the project opportunity,
receiving a set of organization criterion scores for a corresponding set of organization criteria, each organization criterion score representing an evaluation of the project opportunity in regard to a corresponding organization criterion,
receiving a set of partner criterion scores for a corresponding set of partner criteria, each partner criterion score representing an evaluation of the project opportunity in regard to a corresponding partner criterion,
determining an organization preference score, based on combining the organization criterion scores,
determining a partner preference score, based on combining the partner criterion scores, and
generating a graphical representation of the project opportunity, based on the project opportunity data that corresponds to the one or more aspects of the project opportunity; and
presenting the graphical representation of the project opportunity among graphical representations of other project opportunities, based on the organization preference score and the customer preference score.

17. The system of claim 16, the operations further comprising receiving partner stakeholder data that corresponds to one or more partner stakeholders, wherein one or more of the organization criterion scores, one or more of the partner criterion scores, or both, are modified based on the partner stakeholder data, wherein the partner stakeholder data includes, for each of a set of partner stakeholders, a funding value that indicates an amount of funding influenced by the partner stakeholder, and a relationship quality score that indicates a quality of relationship between the partner stakeholder and the organization.

18. The system of claim 17, the operations further comprising:
for each partner stakeholder in the set of partner stakeholders, generating a graphical representation of the partner stakeholder, wherein a size of the graphical representation of the partner stakeholder is proportional to the funding value, and wherein a color of the graphical representation of the partner stakeholder corresponds to the relationship quality score; and
presenting the graphical representation of the partner stakeholder among graphical representations of other partner stakeholders, based on the funding value.

19. The system of claim 16, the operations further comprising:
generating a graphical representation of the set of organization criterion scores and a graphical representation of the set of partner criterion scores; and
presenting the graphical representation of the set of organization criterion scores along with the graphical representation of the set of partner criterion scores.

20. The system of claim 16, wherein the project opportunity data includes data that corresponds to a project value, data that corresponds to a project stage, and data that corresponds to a project date, wherein the operations further comprise:
for each project opportunity in the set of project opportunities to be evaluated, generating a second graphical representation of the project opportunity, wherein an overall size of the second graphical representation of the project opportunity is proportional to the project value, and an interior color of the second graphical representation of the project opportunity corresponds to the project stage; and
presenting the second graphical representation of the project opportunity among second graphical representations of other project opportunities, based on the project date.
